(19) United States
(12) Patent Application Publication
(10) Pub. No.: US 2006/0053215 A1
(43) Pub. Date: Mar. 9, 2006

(54) Systems and methods for providing users with access to computer resources

(75) Inventor: Rohit Sharma, Palo Alto, CA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: MetaMachinix, Inc.

(21) Appl. No.: 10/935,256

(22) Filed: Sep. 7, 2004

(51) Int. Cl. G06F 15/173

(52) U.S. Cl. 709/223

(57) ABSTRACT

Systems and methods for providing multiple users with access to network resources including software applications. A system has an architecture that centralizes and manages computer nodes. The computer nodes include server computers and desktop computers. The centralized computer nodes support multiple instances of different operating systems and are accessed by multiple users through a meta-machine. Users have an n-to-n relationship with the computer nodes and with the operating systems. The computer nodes, the meta-machine, and control nodes are managed by a control plane.

### CROSS-REFERENCE TO RELATED APPLICATIONS

Not applicable.

### BACKGROUND OF THE INVENTION

1. The Field of the Invention

Embodiments of the present invention relate to the field of computers and computer networks. More particularly, embodiments of the present invention relate to systems and methods for providing multiple users with access to computer network resources including computer hardware, software applications, user data, and interconnecting networks.

2. Background and Relevant Art

In conventional computer networks, there are basically two types of computers: desktop computers (including laptop computers) and server computers. Each desktop computer typically contains, for example, one or more processors, Random Access Memory (RAM), a hard drive, network Input/Output (I/O), etc. Desktop computers also typically have an operating system (OS).

The OS is an important aspect of computers An OS typically includes of software which handles the interface to hardware, schedules tasks, allocates storage and other memory, and presents a default interface to the user when no application program is running. The OS may further include a kernel which is always present and various system programs which use facilities provided by the kernel to perform other application or user specific tasks. The OS provides users with access to applications as well as to the local resources of the desktop computer. The OS has become an integral part of the desktop computer and provides a bridge for the user to the various resources of the desktop computer as well as to network resources of the server computers including server-based applications. In fact, many applications cannot be accessed except through the OS. For this reason, both users and applications are dependent on the OS for functioning in the intended manner.

FIG. 1 illustrates, at a high-level, the functional components of a conventional computer. The computer 10 includes a set of applications 12 that receive user input and interface with an operating system 14. Computer 10 also includes hardware 16, such as microprocessors, memory, hard drives, physical layer communication devices, etc. In many cases, the computer model of FIG. 1 is contained with in a single computing device, such as a desktop computer. In other cases, certain components, particularly applications 12, can be stored remotely and accessed through a network. In any of these cases, however, the operating system 14 and hardware 16 is dedicated to the discrete computer 10 and is exclusively linked to a single computer, such as a client computer in a network, and are often exclusively linked to a single user. As noted above, in many cases, the applications 12 are also exclusively associated with a single computer or user.

This concept is further illustrated in FIG. 2, which depicts a set of users and applications 22, a set of operating systems 24, and hardware elements 26. In the conventional computing model, there is a one-to-one relationship between applications, operating systems and hardware. For example, when a user initiates a computing session, an application 27 and a corresponding operating system 29 are operated on hardware 23 in a rigidly defined manner (illustrated by the solid lines). Because of the discrete and self-contained nature of conventional computers, establishing a computing session using (illustrated by dashed lines), for example, application 21, operating system 29 and hardware 31 or a session using application 21, operating system 37 and hardware 39 at the same time on the computer is not possible or presents limitation in intended use of the applications and Operating Systems.

Interconnecting networks of various kinds, including Local Area Networks (LANs) and Wide Area Networks (WANs), enable communication between computers and further enable resources of a remotely located computer (a server computer, for example) to be made available to multiple desktop computers. While desktop computers can provide various desktop applications, have a local OS, and can perform processing at the discretion of the user, networking is utilized to perform various communication functions and provide access to non-local applications but is not utilized to perform resource allocation or control between multiple users connected to multiple computing units. As a result, a typical desktop computer presents a high degree of complexity and cost of administration.

For example, the fact that each desktop computer connected to a network has a has the corresponding cost of administering distributed, but unique, combinations of operating systems, application data, and user data. This cost is not insignificant and can be defined in terms of time and money and also negatively affects reliability of the system. Each desktop computer contains unique user data created as a result of the user interacting with and using the applications available on the computer. Application data, user data, and specific OS data results in unique set of data, configurations, and other user-specific information sets that need to be maintained and stored on each desktop computer.

Today, desktop-based users access various server-based applications through interfaces such as a browser interface or a client-interface on the desktop computer. While this is beneficial in various ways as far as administration of the applications on the servers is concerned, the cost and complexity of administrating the desktop remains high since each desktop computer hosts a unique set of user data and application data that needs to be managed, backed-up, and maintained as well as shared with other users. The user data and the application data are often specific to each user's operating system. In other words, even though more applications are becoming server-based, desktop computers typically still have and rely on independent or stand-alone OS systems for their operation. While these factors permit required operation from a user perspective, they require complex and expensive maintenance and administration activities.

Information technology operations within an enterprise that develops, maintains or upgrades a computer network also include costs of desktop computers and their associated software and hardware. In addition, the enterprise will also face costs associated with the distributed administration of the operating systems of the desktop computers connected to the network. For example, local operating systems are often updated via a software patch made available by the suppliers of the operating system or applications. The patch must be applied to each desktop system individually. Also, a complete representation of composite information about the user, their data, and various other user-specific information, application configurations, etc., are not available at computers other than the user's computer.

Security also becomes more complex and difficult in conventional systems. For instance, care is typically taken to ensure that desktop computers with different operating systems can be accommodated within the network. Different updates are applied to different operating systems. These and other types of activities come with a cost burden that can be measured in terms of at least time and money.

Virus threats and malicious software threats have to be countered at every desktop, i.e., if one of the desktop computers is not patched against a particular threat, it can host and spread the virus to all other computers in the enterprise network. The failure to protect a single desktop computer can compromise critical data. Administrating a collective of unique desktop computers, each with its own combination of user data, application data, and operating system configuration leads to increased complexity and cost of administration.

### BRIEF SUMMARY OF THE INVENTION

These and other limitations are overcome by embodiments of the present invention which relate to systems and methods for providing multiple users with access to computer network resources including hardware, operating systems, network storage, network communications, and software applications. In one embodiment, the users are able to access the network resources independently of the operating system or its existence at the time of startup and during operation.

Embodiments of the invention are able to manage network and computer resources and provide provisioning, monitoring, and operational control of resource allocation to all users according to explicit privileges or access control policies defined, implemented, and controlled by computer administrators. A centralized computer administration architecture has the additional benefit of being low cost. For example, costs of administering users, hardware, and software are reduced and the need to provision, install, upgrade, download, or manage software at desktop computers is eliminated.

In one embodiment, a meta-machine is established that provides an environment for hosting multiple operating systems including one or more control operating systems which have administrative privilege over the various operating systems. The meta-machine operates and manages multiple computers (“computer nodes”) that may be accessed by multiple users on a shared or exclusive basis, with each user utilizing one or more operating systems and resources from one or more computers. The computer-nodes may be commodity, standard hardware commonly referred to as “blades.” The blades can be controlled or dynamically allocated to be server computers running server-based applications or desktop computers, and the like. Some of the blades are dedicated to control functions used to implement a set of management, monitoring, reporting, and maintenance software applications that collectively constitute an administrative plane (also referred to as a control plane) that interfaces with other computer nodes and with the meta-machine.

The meta-machine also interfaces with a plurality of terminals. Because the meta-machine can arbitrate access to the operating systems, users are no longer limited to using the operating system (if any) of their terminal, although conventional desktop computers can be used as terminals. In fact, the terminals typically require minimal hardware/software such as, but not limited to, a display and video driver, a keyboard, a mouse, a peripheral access point, and a network connection. Processing requirements of the users of the terminals are performed in the computer nodes or shared between the terminal and the computer nodes.

For example, computer nodes that are desktop computers may be assigned to a user based on resource utilization policy or other administrative policies, rules, privileges, or mechanisms that yield the optimal management, performance, or cost of administration goal for the organization. The computer nodes assigned to a user can then access other computer nodes (such as computer nodes that are designated as server computers) as needed according to policies set by administrators. The meta-machine also provides access to one or more of the appropriate operating systems. Thus, multiple terminals (and multiple users) can access multiple software and hardware resources within multiple operating systems. Embodiments of the invention enable a many-to-many relationship (where there are several users and several machines and several instances of operating systems) between users, operating systems, and/or hardware/software that can be described, for example, as a matrix in which the nodes represent either users or the resources (computers, networks, hardware, applications), and the interconnecting lines are the policies, rules, privileges embodied in our overall meta-machine.

The control plane or administrative plane, which is often implemented in the computer nodes that are configured as control nodes, provides the messaging, monitoring infrastructure and interfaces to the various components including the computer nodes, meta-machine, and terminals. Often the interfaces can occur over a LAN or WAN and are often implemented redundantly to prevent loss of access or performance in case of failure. The control plane provides complete control and management of the computer resources, including operating systems, all software components, all hardware components, I/O, network access, and the like or any combination thereof.

Advantageously, costs associated with maintaining distributed operating systems on the terminals can be substantially reduced or eliminated. In addition, the computer nodes can be implemented as standardized commodity or bulk hardware such as blade computers to further reduce cost.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example of a computing environment including a set of applications that are associated with an operating system;

FIG. 2 illustrates a computer environment where a one-to-one relationship exists between applications, operating systems, and hardware elements;

FIG. 3 illustrates relationships between user desktops, operating systems, and computer hardware and also illustrates the policies, rules, and administrative privileges between the desktops, operating systems, and hardware/resources.

FIG. 4 illustrates functional components of one embodiment of a system where operating systems are implemented using any hardware in a network;

FIG. 5 illustrates one embodiment of the invention that provides flexibility between applications, operating systems, and hardware devices;

FIG. 6 illustrates a many-to-many relationship between applications, operating systems, and hardware;

FIG. 7 illustrates one embodiment of a system that provides multiple users with access to network resources such that the users have an n to n relationship with the network resources as well as with instances of different operating systems;

FIG. 8 illustrates one embodiment of exemplary layers of a computer architecture that provides multiple users with access to network resources;

FIG. 9 illustrates a physical network implementing the computer architecture of FIG. 8;

FIG. 10 illustrates one embodiment of a meta-machine for which applications are developed;

FIG. 11 illustrates one embodiment of a meta-machine;

FIG. 12 illustrates another embodiment of a meta-machine and illustrates the layers of a meta-machine;

FIG. 13 illustrates a logical view of a units of computation layer of a meta-machine;

FIG. 14 illustrates exemplary software components that cooperate to provide computing resources to users;

FIG. 15 illustrates an example of hardware that can implement the software components illustrated in FIG. 14;

FIG. 16 depicts an embodiment of the invention implemented in an enterprise with existing computing resources;

FIG. 17 illustrates another embodiment of the invention implemented in an enterprise network where an application server and an operating system and meta-machine server share a common hardware infrastructure; and

FIG. 18 illustrates an example of a widely distributed system that enables a user to access computer resources including applications and operating systems remotely.

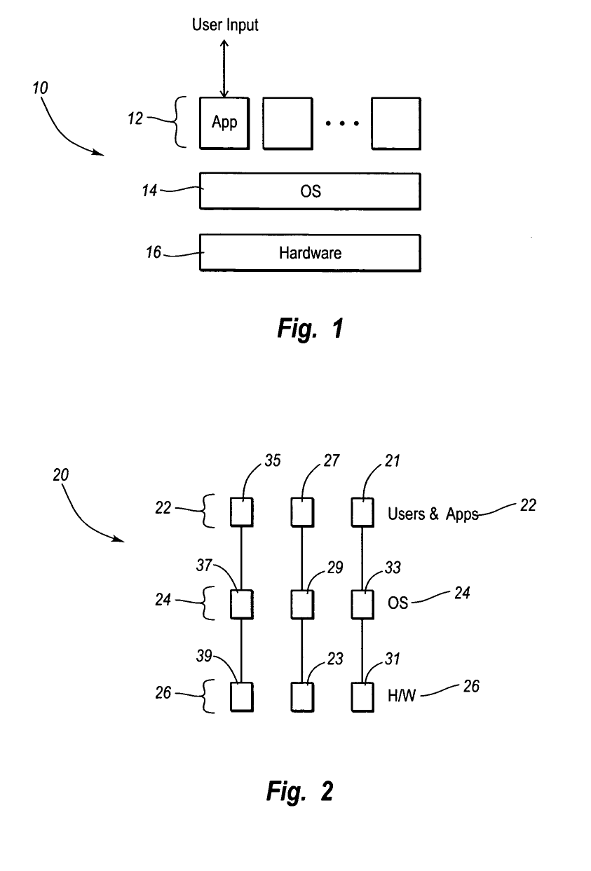

### DETAILED DESCRIPTION OF THE PREFERRED EMBODIMENTS

Embodiments of the invention relate to a computer architecture and to systems and methods for providing multiple users with access to local or distributed network resources. A network may be a local area network (LAN), metropolitan area network (MAN), wide area network (WAN), the Internet and the like or a combination of one or several such networks. The network resources may include, for example, software applications, operating systems, search-engines, memory, other network hardware, network I/O, etc. Resources are allocated to users on the network in a manner that enables the realization of administrative or management goals of the providers and the users of the network.

Embodiments of the invention may operate in an enterprise environment and control or monitor computing resources including mainframes, servers, blades, and the like. Embodiments of the invention provide application and data mobility by permitting access to user data within any network that interfaces or connects to the described invention. Discrete elements of the system and network are unified for management purposes in a single logically defined administrative space. User environments are hosted in conjunction with the unified administrative space. User information can be controlled and displayed or accessed from multiple devices including terminals, desktop computers and displays, remote clients, cellular telephones, personal digital assistants, and other computer terminals.

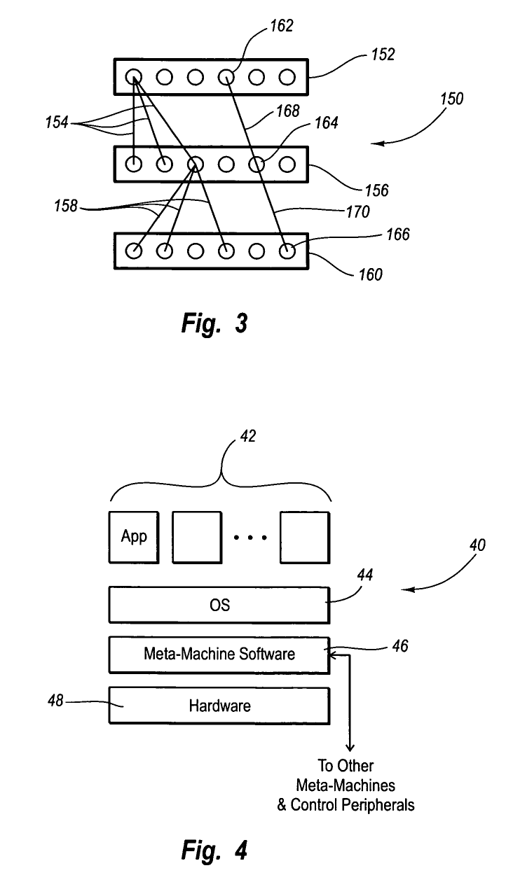

### 1. Relationships Between Applications, Operating Systems and Hardware

Where conventional systems typically have a fixed relationship between users and operating systems and/or network resources, embodiments of the invention enable a flexible, managed plurality of relationships between users, operating systems, and/or other network resources. This is illustrated in FIG. 3, which depicts a matrix representation of user desktops 152, operating systems 156, and resources 160 that have a many-to-many relationship as opposed to the rigid one-to-one relationship between the analogous components of conventional computers as shown in FIG. 2. The relationships 154 and 158 represent the policies, rules, and administrative privileges between the users 152, the operating systems 156, and the resources 160. Users can access an application and the appropriate instance of an operating system is provided. For example, a user at the desktop 162 may access network resources that require the operating system 164. The user is then bound or associated with the operating system 164 and the resources 166 may be used. The policies, rules and privileges are described in the relationships 168 and 170. For another application or purpose, the user may use a different operating system and/or resource. The systems and methods of the present invention manage a composite environment and provide resource allocation, resource monitoring, provisioning, and the like.

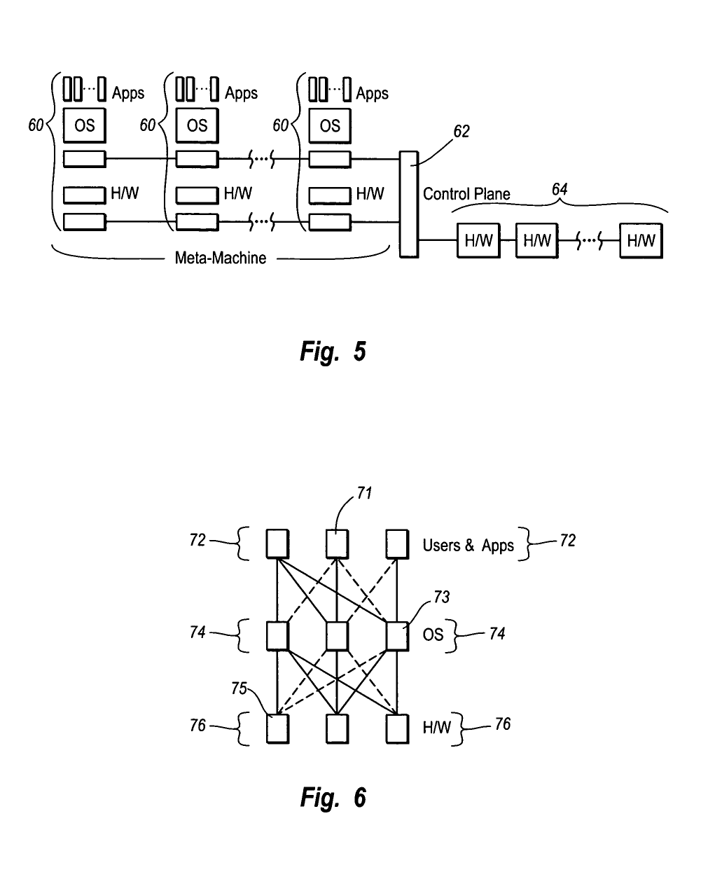

FIG. 4 illustrates the functional components of a computer system configured according to an embodiment of the invention. The computer system 40 of FIG. 4 includes a set of applications 42, hardware 48 and an operating system layer 44. The meta-machine layer 46 enables the operating system to be implemented using hardware devices that may be located anywhere in the network. As shown in FIG. 4 and as described in greater detail below, the meta-machine layer 46 permits and controls access to other hardware devices and various other system resources, operating systems, network storage, network communications, and local or remote software applications through a control plane (as illustrated in subsequent FIGS. 5, 8, 12, and 15).

The architecture of the described system is scalable in order to include multiple unlimited instances of its constituent components as illustrated in FIG. 5, which shows an arbitrary number of the computer systems 60, each system 60 is an embodiment of the computer system 40 of FIG. 4. The control plane 62 allows any of the hardware devices 64 in the network to be used to provide computing and/or networking resources to a user during a computing session. In one embodiment, the hardware components included in each computer system 60 have been allocated to a particular user or sets of users by the control plane 62. When a user session terminates, the previously allocated set of hardware resources having a CPU, memory, network input/output, storage input/output and other services may be released and later reallocated by the control plane 62 as necessary.

FIGS. 4 and 5 illustrate the fact that, according to the present invention, there is no rigid one-to-one linkage between applications, operating systems, and hardware devices. Instead, as depicted in FIG. 6, there can be an any-to-any relationship between applications 72, operating systems 74, and hardware devices 76 mediated or administered by the control plane. Thus, during a particular computing session, a user might access computing resources using applications 71, operating system 73 and hardware 75. For example, the application 71 may be associated with the operating system 73 and the resources 75. The any-to-any relationship is not present in the rigid computer systems depicted in FIG. 2, for example.

Embodiments of the invention free users from the limitations of any particular operating system and also relieve the network from the cost of managing distributed and unique instances of operating systems and user data and combinations thereof. Access to user data, operating systems application data, for example, are not limited to a particular terminal, but are centrally managed, thereby enabling user and application mobility from one terminal to another or from one network to another. Thus, by centralizing the control exercised over network resources, the cost associated with the administration of users, hardware, and software is reduced while providing greater availability of resources. Resource allocation can be optimized while maintaining control over the resources. Advantageously, the need to provision, install, upgrade, download, or manage software to individual user-stations or desktop computers is substantially eliminated.

In one embodiment, terminals access control information and user-specific data that is available at one or more centralized locations. Thus, network resources are available with greater reliability by maintaining the user state in a central or managed location rather than at the terminals. The user state, as well as the application state, and/or the machine state is managed at a central location. The user state is controlled by the system rather than by a specific terminal. One of the benefits of centrally monitoring or controlling the user state is that a user along with their specific configurations, applications, and data can move from terminal to terminal. The user state can also be accessed remotely to provide the user with access to computer resources and different operating systems over widely distributed networks. Embodiments of the invention also enable a user to access multiple operating systems at desktop computers or terminals.

The architecture of embodiments of the present invention includes centralized computing resources. The computing resources may take the form of mainframes, server computers, or commodity or generic computer elements referred to as blades. The blades provide uniform or heterogeneous units of computation. The computing resources, also referred to as computer nodes, can be allocated or partitioned to support the execution of multiple operating systems and applications concurrently. The blades can further be divided into at least desktop computers and server computers. In other words, the resource requirements (such as a desktop computer) of a user at a terminal are selected from the computer nodes and allocated by control nodes. This is accomplished, in one embodiment, using virtualization such that the computer nodes appear as multiple virtual machines. Each virtual machine can support at least an instance of some operating system.

### 2. Components of Computing System and Virtualization

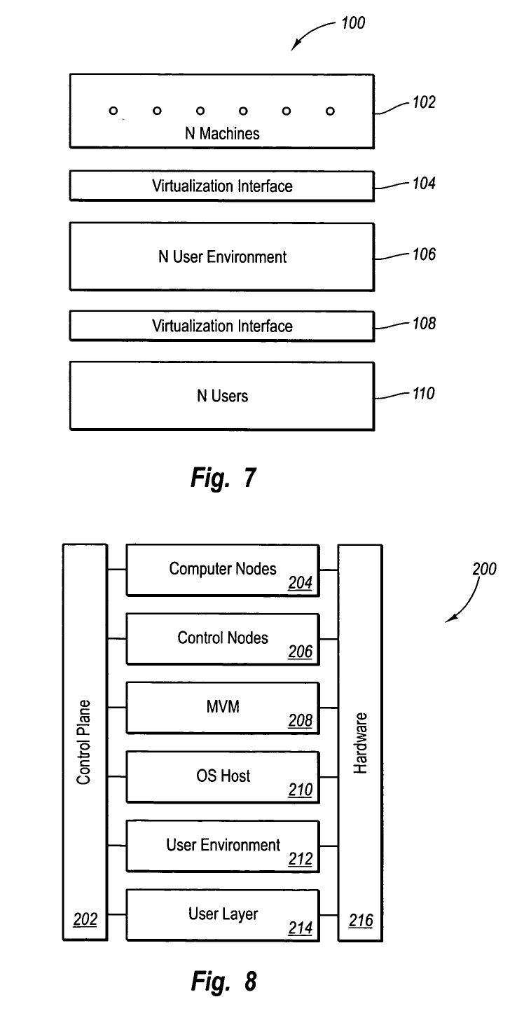

FIG. 7 illustrates a block diagram of one embodiment of a system or machine in accordance with the present invention. Block 102 represents the computing resources or computer nodes and can include both hardware and/or software applications. In a sense, the block 102 represents n machines that can be commodity machines such as blades as previously described. Block 106 represents n user environments and may include multiple operating systems or instances of operating systems.

The block 110 represents multiple user terminals. A virtualization interface 108 is used to couple the plurality of user terminals with multiple user environments. A virtualization interface 104 couples multiple user environments with multiple machines of block 102. The virtualization interfaces are abstract representations of resources, including hardware, software, the control plane, or resources that can operate with other resources or sets of resources as if the resources were connected directly to each other. In this embodiment, the system 100 provides a many-to-many relationship between user terminals, user environments (including operating systems), and computer nodes such as blades.

FIG. 8 illustrates another embodiment of the present invention. The computer nodes 204 and the control nodes 206 are configured as computational nodes and also correspond to the network resources that may be available to users. The computer nodes 204 and the control nodes 206 have associated hardware 216. In one example, the computer nodes 204 and the control nodes 206 typically include, for example, a processor, memory, and network I/O. The blades are typically interconnected by GbE, 10GbE with a switch/router or Myrinet or Infiniband, for example. This enables the blades configured as desktop computers to access other blades configured as server computers.

The control nodes 206 or blades are designated as such and have higher levels of control privileges accessible to computer system administrators. The number and location of the control nodes 206 are set by an administrator. In the event of a failure, the system 200 provides redundancy and secondary control nodes can perform the function of the primary control nodes. Indeed, one of the primary benefits of the many-to-many relationship between applications, operating systems, and hardware components is that the flexible configuration of components that are used in a particular computing session permit hardware or software failures to be quickly overcome without impacting user sessions. For instance, in the event of failure of a particular hardware component, the control blade or node can quickly reallocate another available hardware component to the operating system. Thus, the computing systems configured and operated according to the invention are, in general, high-availability systems.

The computer nodes 204 can be set to perform different functions. For example, some of the computer nodes 204 can be set to be used as desktop computers while other of the computer nodes 204 are designated or allocated as server computers. The computer nodes thus provide the processing power needed by users, applications, the network, etc. For example, when a user logs into or accesses the system 200 from a terminal, certain resources of the computer nodes 204 are bound or allocated to the user and provide the functionality of a desktop computer. The resources of the computer nodes allocated to the user can access other computer nodes which have been allocated as server computers, for example. The processing requirements of the user, the application, the server, and/or the network thus occur and are allocated and managed at a centralized location.

Meta-virtual-machine MVM 208 provides a single environment for hosting multiple operating systems and/or one or more control operating systems. The user environment 212 arbitrates between terminals associated with the user layer 214 and multiple operating systems as illustrated by the OS host 210. Part or all of the MVM 208 may be realized in the hardware 216 to accelerate performance.

The user layer 214 may include the terminal units used to access the computer nodes 204. The terminal units in the user layer 214 have minimal needs that may include, but are not limited to, a display, a video-driver, a keyboard, a mouse, a peripheral access point (USB, Firewire, etc.), and/or a network connection. In one embodiment, a standard personal computer with a network connection may be a terminal for enterprises with existing computer networks.

The control plane 202 includes a system of interconnected software programs that provide a messaging, monitoring infrastructure (both hardware and software) and provides interfaces to all other layers or components of the system 200. The control plane 202 also has redundant links to the network infrastructure and is configured to survive multiple failures in the system 200. The control plane 202 monitors, receives, calculates and transmits control signals to other systems and resources of the computer network. The control plane 202 operates according to decisions, policies, algorithms, or other software programs that have been automated, stored, accessed remotely from one or more other network or networked storage locations or manually determined.

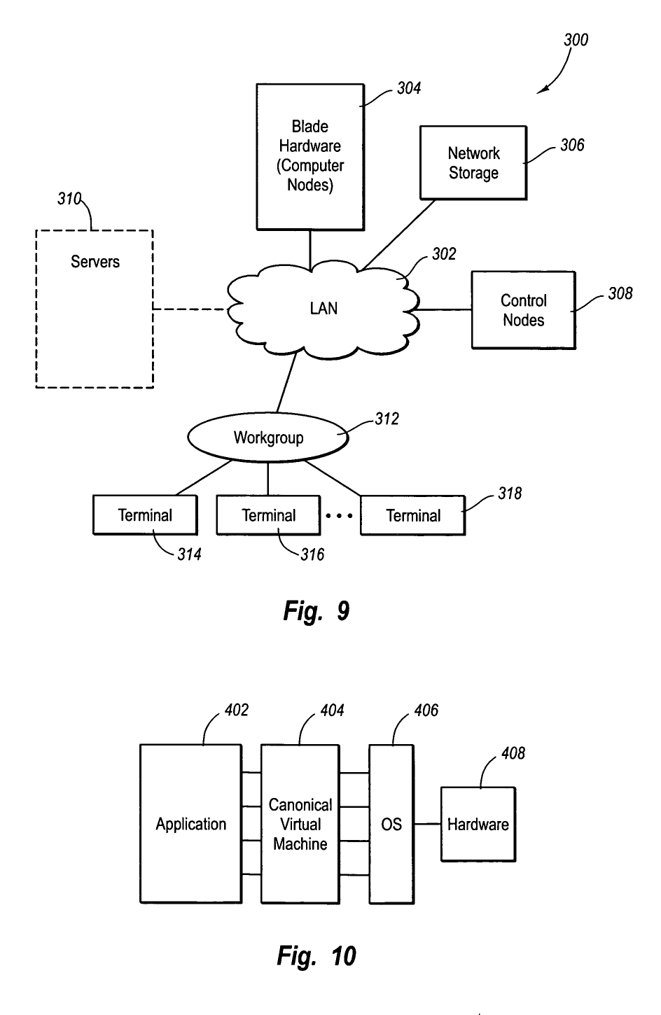

FIG. 9 is a block diagram that illustrates an example network implementing embodiments of the invention. FIG. 9 illustrates a Local Area Network (LAN) 302. The blades 304 are an example of commodity hardware that can be used to provide the functionality of, for example, both servers and desktop computers. The blades 304 are centralized in this example. The blades 304 are an example of the computer nodes and are controlled or managed by the control nodes 308. The control nodes 308 may also be implemented as blades as previously described. In one embodiment, the control nodes 308 are subsumed by the blades 304.

The blades 304 can be organized via the control nodes and, using virtualization, support multiple instances of multiple operating systems. When a user requires resources (including some hardware and/or software and operating system), the control nodes (which may include the control plane illustrated in FIG. 2) can maintain virtual copies of all data and configurations and enable the user to move from one terminal to the next, for example. The data and configurations may include, for example, data about the user, application specific configuration, applications, use policy (access control), an operating system, and the like.

The network storage 306 is an example of memory that may store, for example, applications and data. In this example, the terminals 314, 316, and 318 form a workgroup 312 that has access to the blades 304 and other hardware through the LAN 302. Each terminal may have a display, a video driver, a keyboard, network I/O, peripheral support (for personal digital assistants, for example), local disk support, and the like as previously described. A conventional desktop computer or laptop computer can also be used as a terminal.

The servers 310 can also be partitioned to provide the network resources to the terminals. The servers 310 can thus support instances of multiple operating systems. In other words, existing networks can be converted to embodiments of the invention such that the existing resources can provide multiple users with access to network resources because embodiments of the invention enable a user to access and use multiple operating systems as required or permitted.

In one embodiment, the discrete elements of a conventional system (desktop computers, distributed operating systems, etc.) are unified into a single logically defined administrative-domain or administrative space. The user-environments (including the various operating systems) are hosted and managed within the administrative space. By controlling the user-environments within the administrative space, user-information or the user state can be controlled. The user state can also be tracked and displayed to desktop displays, remote clients, cellular telephones, PDAs, terminals, and the like. Access to the administrative domain is via control plane or administrative plane.

Embodiments of the invention can extend to a canonical virtual machine (CVM) that provides all necessary and required elements of a machine (processing, memory, network I/O, etc.) By defining a virtual machine in these terms, as shown in FIG. 10, the canonical virtual machine 404 can mediate between operating systems 406 and applications 402. In other words, an application can be developed to a canonical virtual machine 404 definition and be independent of the operating systems 406. Thus, the application-user interaction becomes independent of the operating system and the development of the applications in this environment can be done once instead of multiple developments to permit use with multiple operating systems. The canonical virtual machine 404 can respond to the requirements of the applications 402 without requiring applications to be developed various requirements of the operating systems. The canonical virtual machine 404 accesses the appropriate operating system and other computer resources as needed by the application 402.

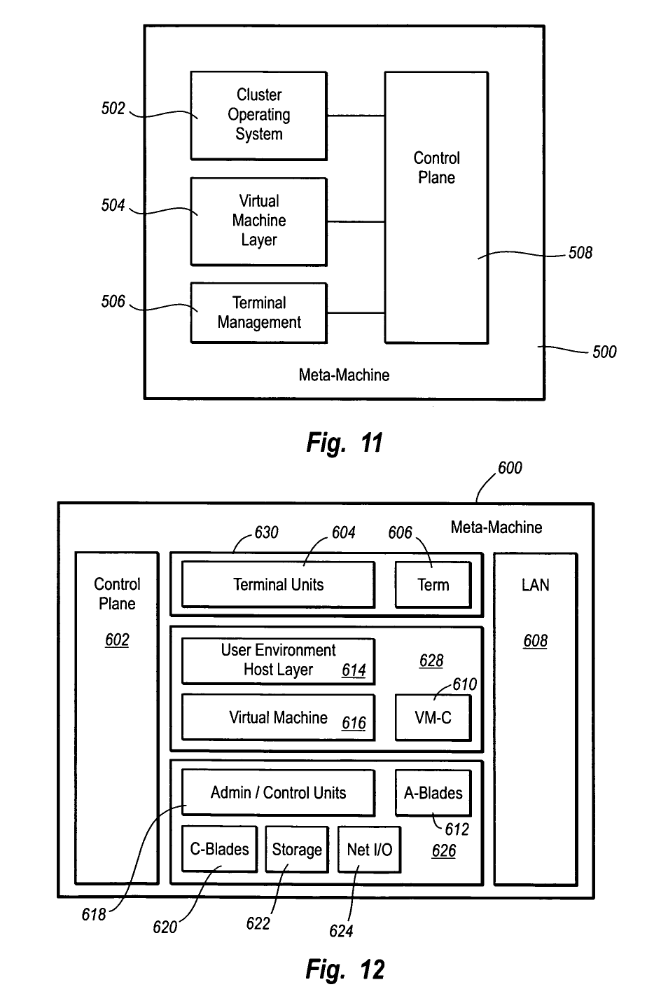

FIG. 11 illustrates one embodiment of a composite meta-machine 500. The meta-machine 500 or some of its components provides a system of communications, control, and command of all resources in, for example, an enterprise that are needed to provide monitoring and control of all resources. The control plane is one embodiment of such a system. A control class of users (system administrators) can use the control plane.

An exemplary meta-machine 500 includes a cluster operating system 502 used to manage and control several computers or servers as if it only included of a single machine or a single administrative domain. The cluster operating system 502 may include a control operating system, a meta-cluster definition including one or more clusters organized within the principles of meta-machines described earlier, and a rack level or frame level operating system. The virtual machine, or meta-machine, layer 504 may include a virtual machine definition using various blades, a control operating system and a guest operating system.

The terminal management 506 includes desktop and display management, audio and/or video performance, peripheral device support, and laptop/itinerant machine interface. The control plane 508 is connected with the cluster operating system 502, the virtual machine layer 504, and the terminal management 506. The control plane 508 provides communications and command. The control plane 508 provides network and resilience metrics or mechanisms. The control plane 508 also provides an interface to, by way of example, storage, network I/O (WAN), network hardware (LAN), security applications and appliances, billing systems, SLA creation/control/management.

FIG. 12 illustrates another embodiment of a meta-machine 600. The meta-machine 600 includes units of computation in a first layer 626. The units of computation include computer nodes and control nodes in one example. The layer 626 may include hardware such as a CPU, RAM, storage I/O, Network I/O that may be embodied as server or desktop blades 612. Storage 622 and network I/O 624 are also included in the units of computation. Some of the blades may be control blades 620, which have higher levels of control-privileges. In the event of failure, designated secondary control units may be made available.

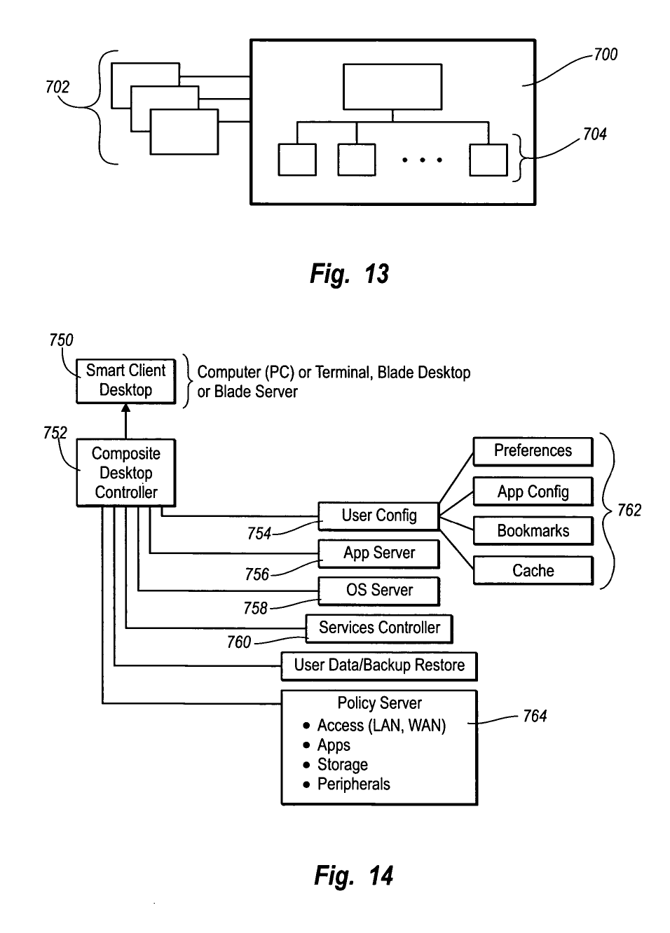

FIG. 13 represents a logical view of the layer 626 illustrated in FIG. 6. The control terminals 702 can be connected to any computer or control unit (blade, for example) in the cluster 700. The cluster 700 of units 704 (control and computer units) is administered as a single computer unit in this example. The control terminals 702 have complete control of all user-processes, machine processes, and control functions. In addition, one or more of the computer units may reside at the user location in the form of, for example, a desktop computer.

Returning to FIG. 12, the layer 628 is a machine virtualization layer that provides a single environment for hosting multiple virtual operating systems and/or one or more control operating systems. The user environment host layer 614 arbitrates between a plurality of users and a plurality of operating system interfaces. The virtual machine 616 may be associated with a virtual machine controller 610 that is realized in hardware and that may accelerate performance or provide a mediated access interface between virtual machine software and various specialized computer hardware and configurations.

The layer 630 includes terminal units 604 that, as previously described, have minimal hardware and/or software. An exemplary terminal may include a display, a video-driver, a keyboard, a mouse, a peripheral access point. A standard desktop computer with a network connection may also be a terminal. Existing desktop computers, for example, can be terminals.

### 3. Software Embodiments

The Figures referenced above have been used to describe embodiments of the invention in terms of the physical configuration of network components that cooperate to provide computing resources to users and in terms of the basic functional components (e.g., user terminal, operating system, applications) that can be used to perform these methods. FIG. 14 illustrates a conceptual, software view of the operation of these systems according to embodiments of the invention. Each of the software or conceptual elements of FIG. 14 can be physically implemented in a single virtual or physical machine or across multiple virtual or physical machines and interact through the control plane.

FIG. 14 shows a client device 750, which can be, for example, a conventional personal computer; a client terminal that includes a display device, a keyboard and a mouse; a blade desktop; or a blade server or servers. A “composite desktop controller” 752 having one or more of the following; User Environment Host Layer 614, Virtual Machine 616, and Admin/Control Units 618 generates a user interface that allows the user to access applications and operating systems and input data and otherwise engage in a computing session. As described below, the composite desktop controller 752 provides the user interface by generating a composite of the data obtained from the elements illustrated in FIG. 14.

In particular, these elements include user-state information 754, an application server 756, an operating system server 758, a services controller 760, user data 762, and a policy server 764. User state information 754, an application server 756, an operating system server 758, a services controller 760 reside on blades/commodity hardware as previously described in FIGS. 5, 9, 12. The user state information, which is described in greater detail below in reference to FIG. 18 specifies the data, applications, application-specific configuration, use policy, operating systems, and other aspects of a computing system that together represent the elements needed to replicate a particular computing session for a user. The application server 756 and operating system server 758 provide access to applications and operating systems, respectively, and are described in greater detail elsewhere in this document.

The services controller 760 instantiates and manages various user-specific services including but not limited to access to applications, local area networks, wide area networks, storage networks, etc. The policy server 764 implements a description of access and use privileges, rules, and other administrative functions as desired in an enterprise.

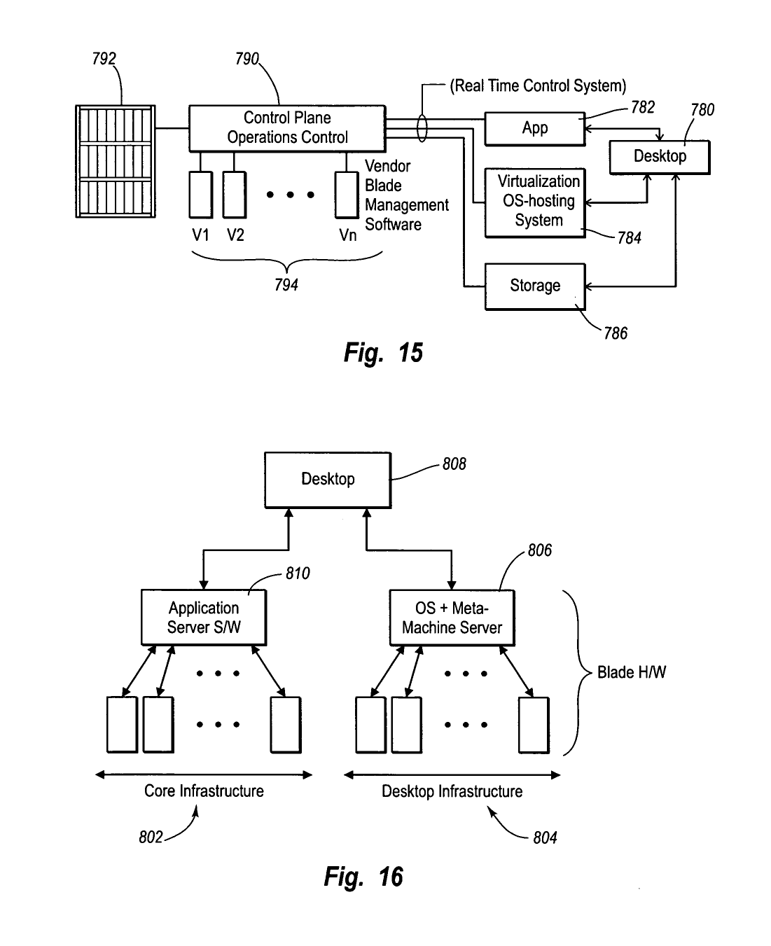

FIG. 15 illustrates a system hardware view of an embodiment of a network that can be used to implement, for example, the software system of FIG. 14. FIG. 15 shows a client device 780, or desktop computer, that communicates with an application 782, a virtualization system 784 that provides operating system hosting, and storage hardware 786. These components are controlled by a control plane 790 that communicates with a physical cluster of PC or server blades 792, which can be obtained from a single vendor or multiple vendors. The control plane 790 also operates with vendor-specific blade management software 794 that is associated with corresponding vendor-specific computer or server blades 792.

### 4. Integration with Existing Enterprise Networks

The computer system architecture of the invention is flexible and can be adapted to the existing hardware and computing resources of substantially any enterprise that adopts the system. In general, existing computer networks can be adapted to operate according to the invention by installing software and often with little or no physical reconfiguration of hardware components.

FIG. 16 illustrates the manner in which the invention can be applied to an enterprise network that has existing hardware that has separate core infrastructure 802 and desktop infrastructure 804, either or both of which can be based on commodity, standardized blade hardware. In this example, the core infrastructure 802 is used to implement an application server 810 that provides applications to computers. In many cases, enterprise networks have such application servers that exist prior to the networks being upgraded to perform according to the invention.

According to this embodiment, the existing application server 810 and core infrastructure 802 are integrated into the system that has an operating system and meta-machine server 806 that operates on the desktop infrastructure 804 of the network. Rather than using dedicated and exclusive operating systems, the desktop computer 808 of FIG. 16 accesses all operating system resources from operating system and meta-machine server 806. In this example, the application server 810 and the operating system and meta-machine server 806 use different hardware infrastructures that exist in the enterprise.

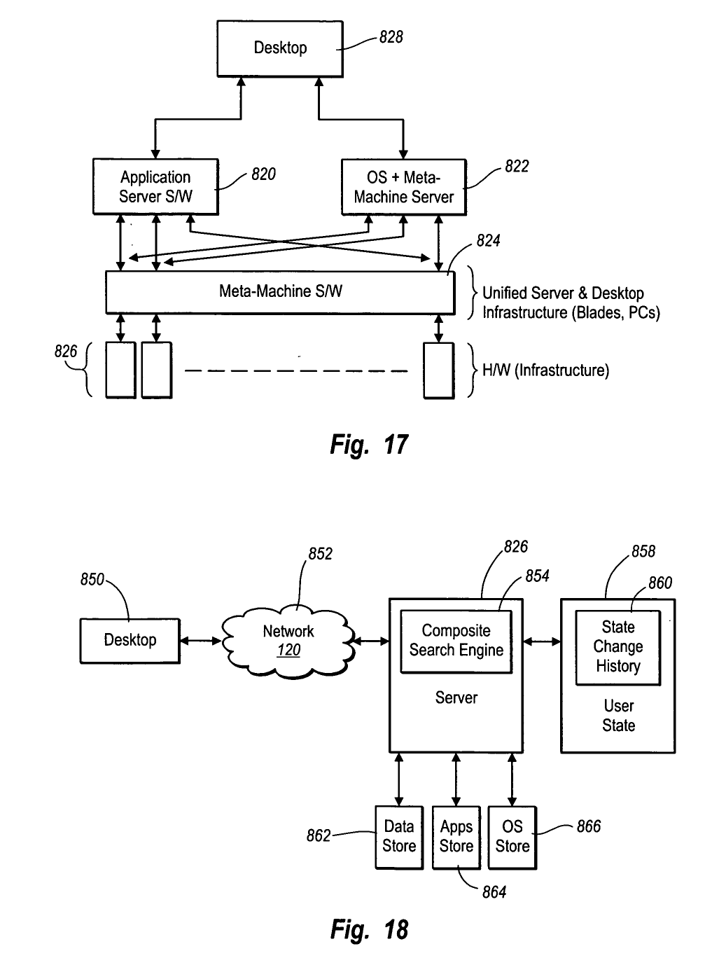

FIG. 17 illustrates an alternate way in which the networks and computing architectures of the invention can be implemented in an enterprise network. FIG. 17 depicts an application server 820 and an operating system and meta-machine server 822 that share a common hardware infrastructure 824, which can be implemented using blades, personal computers, etc. In this embodiment, all of the hardware resources are available to either the application server 820 or the operating system and meta-machine server 822 and can be flexibly allocated to these components as needed providing benefits of greater availability, higher efficiency, lower capital costs and ease of management.

FIGS. 14 and 17 also illustrate the concept that virtualization of a machine according to embodiments of the invention involves two layers of virtualization. First, the servers can be virtualized in ways that enable applications to be accessed without requiring a one-to-one linkage between applications and users and that provide load balancing, recovery functionality, and high availability. Second, the desktop computers can be virtualized by managing the operating system resources as described herein.

### 5. Widely Distributed Networks

Embodiments of the invention have been described hereinabove in the context of computing resources that are locally distributed in a local area network. However, the principles of the invention can be applied to networks and computing systems in which the components are distributed in substantially any manner provided that the bandwidth between components is sufficiently high to give the user an acceptable computing experience.

Rather than being limited to the distribution of elements in a local area network, any of the operating systems, virtual machines, meta-machines, hardware, applications, and other computing resources can be located in remote points in a wide area network, such as the Internet, a metropolitan area network, or any other such network, assuming that sufficient bandwidth exists.

In this widely distributed model, the control machines (i.e., servers and storage) and applications reside remotely and can be invoked as needed through the Internet or another wide area network using search queries including user-input text or data that is used to search for appropriate and relevant data that exists on the distributed components of the system described previously. Search queries in this embodiment perform a function similar to that of accessing the control planes described herein. The search queries and the results of the search are used to preferentially or beneficially link the components of the system and to permit resources and applications to be made available to users. The nature of the search queries is not critical, and conventional search technologies, such as text-based or content-based searches, can be readily adapted for use with embodiments of the present invention.

Search requests can be generated by a computer independent of its operating system at the Basic Input/Output System (BIOS) level. Such requests can be interpreted by a composite search machine, which is a software program having multiple search engines and a system for searching through the contents of the servers, and sent to the appropriate destination, such as a data store, an application store, or an operating system store or another set of search engine servers. When a computing session is initiated, the initial search query can be composed based only on a login name and a password or other authenticating information.

One benefit of this computing model is that as the size of applications increases and as the amount of data that might be associated with a particular user is in the tens or hundreds of gigabytes and approaches the terabyte level, the magnitude of such data cannot be conveniently accessed and managed in conventional ways. Typical computing models, in which user data is stored locally and large applications are exclusively associated with individual users, cannot be easily scaled to significantly larger magnitudes. The computing models of the invention prevent each personal computer from having to permanently possess a copy of each piece of code. As required, applications are retrieved from a remote repository or are obtained from a software vendor. Applications can also be cached locally to reduce bandwidth requirements. Similarly, other data can be cached locally, such as user data and information specifying the user state or operating system state.

Another benefit of this system is that a personal computer can access significantly greater computing resources as needed or can access specialized applications that might not otherwise be easily accessible. For example, a computer user who has the need to access an application on a one-time basis or a limited number of times can use the system to request access to the application. The application can be provided by a software vendor who operates within the framework of the network architecture disclosed herein.

While substantially any type of application can be made available through this system, it can be particularly useful for complex applications, such as scientific and engineering modeling applications, numerical analysis systems, digital image processing and storage, internet-scale searches, digital music, etc. In addition, when an application that is made available through this system requires a large amount of processing power, additional hardware (e.g., remote processors) can be made available on an ad hoc basis.

When the application that is to be accessed is one that is provided in an on-demand basis by a software vendor, the software is stored remotely in a manner similar to the storage of an application in a remote application store. In the case of providing on-demand access to software by a software vendor, the software transaction can be performed by executing an electronic financial transaction. The alternate scenario is one in which the application is either an open-source or shareware program or the application has already been purchased by the user or a group of users and is stored remotely in an application store. In either case, the application code does not need to be exclusively linked to a particular user or particular hardware, and the code does not need to be permanently stored locally.

Because a desktop or personal computer no longer needs to be associated permanently or exclusively with a particular user, the state of the computing system as it relates to individual users is tracked and stored in system components other than the desktop computer. This feature permits a user to access computing resources as if a specific dedicated computer existed (i.e., a virtual personal computer). One embodiment of tracking the user state involves storing the user state at a location separate from the terminal or personal computer through which the user accesses computing resources. When the user initiates a session, a data structure with information specifying the user state can be made available to the user to properly configure part or all of the computing system at the user location and to track any changes in the user state. The conventional Concurrent Version System (CVS) for achieving version control on data that is changed incrementally can be applied to the user state information. Thus, previous user states can be maintained, and updated user states can be obtained by tracking and storing the deltas, or incremental changes, to the user state over time.

The user state typically includes the data, applications, application-specific configuration, use policy, operating systems, and other aspects of a computing system that together represent the elements needed to replicate a particular computing session for a user. With sufficient bandwidth, secure communications, and search-based access control, the complete state of a user session can be made available in real time, which enables a computing session to be established at any network-accessible computer. The user-state data is stored and checked out by a user such that the computing session can be established, during which time the user-state data is operated upon and changed as necessary.

Because the user-state is stored and updated and because all of the computing resources, with the exception of a local terminal, can be located remotely with respect to the user, a computing session that permits users to access all of the users' applications, data, etc., can be initiated and established at any terminal that has the capabilities for issuing appropriate search queries and otherwise communicating with the network as disclosed herein. For example, users can access computing resources in this manner from Internet kiosk terminals, from computers located at work, from cellular telephones equipped with data access capabilities, personal digital assistants, at home, or other locations, etc.

FIG. 18 illustrates one embodiment of a widely distributed network. In this example of a widely distributed network, the desktop 850 can communicate with a server 854 over a network 852 such as the Internet or a WAN. The server 854 stores or has access to a user state 858. As previously described, the user state 858 enables the complete state of a user session to be made available and enables a computing session to be established through the desktop 850, even when the desktop 850 is a computer that is not normally used by the user.

The user state 858 also includes a state change history 860. In effect, the current user state can be determined by starting with a particular state and then adding or compiling the change history 860 into the user state. In fact, the user-state as it existed at a particular point in time can also be established by accessing the history 860 based on the particular point in time.

With the user-state 858, the server can access the data store 862, the application store 864, and the OS store 866 to provide the computer resources needed by the user to perform tasks in the distributed network. In one example, using the user state 858, a user can “check-out” data, applications, OS-related services, and data and operate on them and change them as needed during a computing session or across multiple computing sessions.

As described above, a search query from the desktop 850 may be received at a composite search machine 856 associated with the server 854. The server 854 may be a server farm in one example. The search query from the desktop 850 is interpreted and sent to the appropriate cluster (data store 862, application store 864, or OS store 866). The search queries link components of the system and permit computer resources to be made available to users. In this manner, a user can access computing resources from any computer as if it were the user's dedicated computer.

### 6. Operating Environments and Terminology

The embodiments of the present invention may comprise a special purpose or general-purpose computer including various computer hardware, as discussed in greater detail below.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

The following discussion are intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those skilled in the art will appreciate that the invention may be practiced in network computing environments with many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

I claim:

1. A system for managing resources in a computer network, the system comprising:
a control plane including at least one control node which permits the exercise of control plane functions;
a plurality of computer nodes that are connected to the control plane; and
a meta-machine that provides an environment for hosting multiple virtual operating systems in the plurality of computer nodes, wherein the meta-machine is controlled by the control plane.

2. A system as defined in claim 1, wherein the control plane comprises a system of interconnected software programs that monitor, receive, calculate and transmit control signals to other systems and resources of the computer network.

3. A system as defined in claim 2, wherein the control plane operates according to decisions, policies, algorithms, or other software programs that have been automated, stored, accessed remotely from one or more other network or networked storage locations or manually determined.

4. A system as defined in claim 1, further comprising a plurality of terminals that access the plurality of computer nodes through the meta-machine.

5. A system as defined in claim 4, wherein the meta-machine provides:
a virtualization interface that is connected to the plurality of terminals; and
a virtualization interface that is connected to the plurality of computer nodes, wherein the virtualization interfaces are abstract representations of resources including hardware, software, control plane, or resources that can operate with other resources or sets of resources as if the resources were connected directly to each other.

6. A system as defined in claim 1, wherein the plurality of computer nodes further comprise commodity hardware including blade computers that provide heterogeneous units of computation.

7. A system as defined in claim 6, wherein blade computers further comprise blade servers and blade desktop computers.

8. A system as defined in claim 7, wherein the blade computers are allocated to the plurality of terminals by the control plane.

9. A system as defined in claim 1, wherein multiple instances of different operating systems are instantiated on the plurality of computer nodes.

10. A system as defined in claim 1, wherein the control plane is implemented in a plurality of computer nodes of the system that operate as control nodes.

11. A system as defined in claim 10, wherein the control plane provides a messaging, monitoring, and control infrastructure that interconnects the computer nodes, the control plane, the meta-machine and a plurality of terminals included in the system.

12. A method for providing access to network resources of a network, the method comprising:
in response to input from a user at a terminal in the network, communicating with a machine virtualization or control plane layer of the network to initiate a computing session in which network resources are to be allocated to the user;
by a control plane operating in the network, dynamically selecting and allocating to the user:
an operating system of one of a plurality of computer nodes of the network; and
hardware resources of another of the computer nodes; and
in response to the dynamic selection and allocation of the operating system and hardware resources, presenting data at the terminal that has been generated using the operating system and hardware resources.

13. A method as defined in claim 12, wherein the operating system and hardware resources are dynamically selected and allocated in a way that establish a many-to-many relationship between users, operating systems and hardware or software resources permitting multiple users to connect to and utilize multiple operating systems and hardware or software resources.

14. A method as defined in claim 12, wherein the control plane operates within a meta-machine that provides an environment for controlling a plurality of computer nodes that hosting multiple operating systems.

15. A method as defined in claim 12, further comprising, by the control plane operating in the network, dynamically selecting and allocating to the user an application that is implemented in a computer node that operates as a server.

16. A method as defined in claim 12, further comprising, during the computing session, performing messaging and monitoring infrastructure of the computer nodes by the control plane.

17. A method as defined in claim 12, further comprising maintaining user state information that defines a user state that is associated with the user and represents the elements needed to replicate a particular computing session for the user.

18. A method as defined in claim 17, wherein the user state information specifies the elements of the computing session that are needed to enable the computing session to be replicated.

19. A method as defined in claim 12, wherein the terminal and the plurality of computer nodes are located in a local area network.

20. A method as defined in claim 12, wherein at least some of the plurality of computer nodes are located remotely with respect to the terminal in a wide area network.

21. A method as defined in claim 20, wherein communicating with the machine virtualization layer comprises transmitting text strings or binary data representations of search queries used by the control plane to dynamically select and allocate the operating system and hardware resources.

22. A method as defined in claim 12, further comprising:
terminating the computing session; and
releasing the allocated operating system and hardware resources such that the operating system and hardware resources are available to be allocated to other users.

23. A system for providing multiple users with access to network resources including software applications, the system comprising:
a cluster operating system including a control operating system;
a meta-machine layer that interfaces with the cluster operating system such that instances of different operating systems can be instantiated for different users; and
a control plane having an interface with the meta-machine and with the cluster operating system, wherein the control plane manages the meta-machine and the cluster operating system.

24. A system as defined in claim 23, further comprising a plurality of terminals that interface with the meta-machine layer.

25. A system as defined in claim 24, wherein each terminal has one or more of:
desktop computer and graphical display management;
audio and video device drivers;
support for external peripheral devices; and
local disk support including read-only and read-write memory systems.

26. A system as defined in claim 24, wherein the plurality of terminals and the cluster operating system are located in the same local area network.

27. A system as defined in claim 24, wherein:
the plurality of terminals and the cluster operating system are located in multiple local area networks; and
at least some of the plurality of terminals and the cluster operating system are connected to each other directly or through other networks.

28. A system as defined in claim 24, wherein at least some of the plurality of terminals are located in a remote portion of a wide area network with respect to the cluster operating system.

29. A system as defined in claim 23, further comprising a plurality of blades that are controlled by the control plane, wherein each of the plurality of blades is configured to provide a server or a desktop computer function.

30. A system as defined in claim 23, wherein the plurality of blades are computer nodes that may be accessed by any of multiple users.

31. A method for responding to failure of a component in a network;
establishing at least one virtualization interface between one or more applications, one or more operating systems, and one or more terminals of the network, wherein the one or more applications and the one or more operating systems share computing resources;
using a control plane of the network, logically connecting the at least one virtualization interface, the one or more applications, the one or more operating systems, and the one or more terminals to establish a configuration of network components used in a computing session; and
using the control plane, and in response to failure of a network component in the configuration, identifying another available network resource that replaces the failed network component and wherein the replacement network resource is located within the same local area network or remotely accessed through other networking means.

32. A method as defined in claim 31, wherein the virtualization interface is an abstract representation of resources that can operate with other resources or sets of resources as if the resources were connected directly to each other.

33. A method as defined in claim 31, wherein identifying the other available network connection comprises logically connecting the other available network component into the configuration of network components used in the computing session.

34. A method as defined in claim 31, wherein the failed network component comprises a hardware component.

35. A method as defined in claim 34, further comprising dynamically allocating operating system resources for use with the other available network component.

36. A method as defined in claim 31, further comprising maintaining user state information that identifies the network components associated with the computing session and updating the user state information in response to identifying the other available network component.

37. A method for providing computer resources to a remote user over a widely distributed network, the method comprising:
receiving a search query at a server from a user, wherein the search query:
has been generated by a terminal that is associated with the user and is remote with respect to the server; and
defines or identifies computing resources that permit the user to engage in a computing session;
in response to the search query, accessing user state information that is associated with the user and stored at the server;
interpreting the search query to identify computing and networking resources required by the user, wherein the computing and networking resources include an application or an operating system residing in a computer node of the network that is remote with respect to the terminal; and
providing the computing resources to the user in a manner that is consistent with the user state.

38. A method as defined in claim 37, wherein the computing and networking resources further include data residing in a computer node of the network that is remote with respect to the terminal.

39. A method as defined in claim 37, further comprising maintaining both the user state and a user state history, the user state history including changes to the user state.

40. A method as defined in claim 39, further comprising identifying a user state for a particular point in time using the particular point in time to identify changes to the user state from the user state history.

41. A method as defined in claim 37, wherein the user state includes elements needed to replicate a particular computing session for the user, the elements including one or more of user data, an application specific configuration, one or more applications, a use policy, and an operating system.

42. A method as defined in claim 37, further comprising maintaining the user state in real time.

43. A method as defined in claim 37, further comprising accessing an application from a software vendor, such that the application is made available to the user in an on-demand basis.

44. A method as defined in claim 37, wherein receiving the search query is performed after the search query has been transmitted from the user over the Internet.

45. A method as defined in claim 37, wherein the search query is generated by the terminal independently of an operating system of the terminal using a basic input/output system.

46. A method for maintaining user state information that enables a computing session of a user to be replicated, the method comprising:
storing, at a server in the network, user state information that specifies resources of the network that are associated with a computing session of the user;
upon receiving a request from a user that is generated at a remote terminal, accessing the user state information to identify said resources associated with the computing session of the user; and
as the user state changes during a computing session of the user that has been established, updating the user state information at the server.

47. A method as defined in claim 46, further comprising, after accessing the user state information, allocating the identified resources based on the user state information so as to establish the computing session.

48. A method as defined in claim 46, wherein accessing the user state further comprises communicating or transmitting the user state out to the user.

49. A method as defined in claim 46, wherein the request is received in the form of a search query over a widely dispersed network or the Internet.

50. A method as defined in claim 46, wherein updating the user state information comprises establishing a user state history that includes a chronological representation of the user state during a series of computing sessions.

51. A method as defined in claim 48, further comprising:
terminating the established computing session;
at a later time, upon receiving another request from the user that is generated at another remote terminal, accessing the updated user state information; and
allocating the resources based on the updated user state information so as to replicate the established computing session for the user through said other terminal.
